(19) United States
(12) Patent Application Publication
(10) Pub. No.: US 2016/0070626 A1
(43) Pub. Date: Mar. 10, 2016

(54) ASSESSING QUALITY OF SERVICE PROVIDED BY APPLICATIONS BASED ON HOSTING SYSTEM SUPPORT

(71) Applicant: Microsoft Corporation, Redmond, WA (US)

(72) Inventor: Chetan Pentam Raghavendra, Kirkland, WA (US)

(21) Appl. No.: 14/479,176

(22) Filed: Sep. 5, 2014

(51) Int. Cl. G06F 11/20; G06F 21/53; G06F 21/57; G06F 11/14

(52) U.S. Cl. CPC G06F 11/2025; G06F 11/1464; G06F 21/53; G06F 21/57; G06F 2201/84; G06F 2221/034; G06F 2221/0735

(57) ABSTRACT

A system for assessing the quality of a service provided by an application hosted by a hosting system is provided. An assessment system generates a data storage score that indicates the data storage support provided by the hosting system to the application. The assessment system may also generate a computational score that indicates the computational support provided by the hosting system to the application. The assessment system may also generate a security score that indicates the security support provided by the hosting system to the application. The assessment system then generates a service score by combining the data storage score, the computational score, and the security score. The assessment system then provides the service score as an indication or certification of the quality of the service provided by the application that is hosted by the hosting system.

### BACKGROUND

A person who needs to select a application (i.e., application program) for business or personal use may find it difficult to identify the application that best meets their needs. For example, an accounting firm may want a cloud-based customer relationship management (“CRM”) application to help track and analyze information about its customers. The accounting firm may need to use the application 24/7 from its offices around the world, may need very fast response time, and may need reliable data storage. As another example, a person may want a photo-editing application for a smart phone for editing family photographs and storing the photographs at a remote server.

When selecting an application that best meets their needs, a person typically reviews literature provided by the application provider. The person, however, may be skeptical of the application provider's claims (e.g., 365/24/7 availability) and may think they are just advertising hype. Such a person may look to other sources for independent assessments of the application. Such other independent assessments include customer reviews, popularity rankings, product reviews, and so on. These independent assessments are primarily subjective and may be based primarily on the needs of the person providing the assessment. For example, a customer who wants rapid response time may provide a negative review for an application with a response time that does not meet that customer's expectation, even though the application may otherwise provide superior functionality. Another customer who wants superior functionality may provide a positive review for that same application even though the response time is somewhat slow. As another example, popularity rankings (e.g., 100,000 customers) are inherently based on the subjective assessment of the people who use the application. Even product reviews by third-party review organizations are primarily based on the subject assessments of the reviewer.

For cloud-based applications, some techniques have been proposed to track and report the key performance indicators (“KPIs”) of cloud infrastructures. These KPIs include tracking the speed of processors and memory, the scaling latency (e.g., adding new resources as needed), the storage performance (e.g., speed), response time, and so on. Even if these KPIs provide an accurate overall assessment of the cloud-infrastructures, they are just an average or ideal assessment and may not be representative of any individual application hosted by the cloud infrastructure.

### SUMMARY

A method and system for assessing the quality of a service provided by an application are provided. In some embodiments, an assessment system generates a data storage score to indicate the data storage support provided for the application. The assessment system may also generate a computational score to indicate the computational support for the application. The assessment system may also generate a security score to indicate the security support provided for the application. The assessment system then generates a service score by combining the data storage score, the computational score, and security score. The assessment system then provides the service score as an indication or certification of the quality of the service provided by the application. The application may be hosted by a hosting system or interfaces with a software system hosted by a hosting system that provides the data storage support, the computational support, and the security support. The assessment system may also generate a performance score to indicate the performance of the application and factor that performance score into the service score.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates a cloud infrastructure.

FIG. 2 illustrates a display page for providing a quality of service score for an application in some embodiments.

FIG. 3 illustrates a display page for assisting an application provider in analyzing the impacts of different levels of protection on the quality of service score in some embodiments.

FIG. 4 is a block diagram that illustrates components of the assessment system in some embodiments.

FIG. 5 is a flow diagram that illustrates the processing of an assess quality of service component of the assessment system in some embodiments.

FIG. 6 is a flow diagram that illustrates the processing of a generate data storage score component of the assessment system in some embodiments.

FIG. 7 is a flow diagram that illustrates the processing of a generate computational score component of the assessment system in some embodiments.

FIG. 8 is a flow diagram that illustrates the processing of a generate security score component of the assessment system in some embodiments.

FIG. 9 is a flow diagram that illustrates the processing of a code analysis component of the assessment system in some embodiments.

FIG. 10 is a flow diagram that illustrates the processing of an execution analysis component of the assessment system in some embodiments.

### DETAILED DESCRIPTION

A method and system for assessing quality of the service provided by an application that may be hosted by a hosting system or interface with a software system hosted by a hosting system is provided. In some embodiments, an assessment system generates a service score as an indication or certification of the quality of service provided by an application. The service score may be provided, for example, by an application store to assist users in selecting applications to download to their devices or selecting which hosted application to use. The assessment system may determine the quality of service of an application based on the support provided by the hosting system to the application. For example, a hosting system may offer automatic replication of data and computers with graphic processing units (“GPU”). Each application provider may select different combinations and different levels of support for their application. One application provider may select very secure encryption for the stored data and may not select a high level of geographic distribution of data centers. Another application provider, in contrast, may not select any encryption of stored data and may select a high level of geographic distribution of data centers. The assessment system generates scores for various types of support provided by a hosting support to an application and may combine those support scores into an overall service score for the application. Because the support scores are generated based on the support provided by the hosting system, the support scores tend to be much more objective than other assessments such as customer reviews.

A hosting system may be a cloud infrastructure with multiple data centers at geographically dispersed locations such as the United States, Brazil, Germany, and Japan. Each data center may have thousands of computers (i.e., data center servers) and data storage units. The cloud infrastructure may also provide front-end centers with front-end servers (e.g., edge servers) at even more geographically disperse locations such as in Canada, Mexico, Russia, Kenya, China, India, and so on. These front-end centers are connected to the data centers and allow users to connect to a data center via a front-end server that is geographically close to the user. An application may have some of its functionality provided by the front-end servers (e.g., serving locally caches web pages), but its primary functionality (e.g., data storage) may be provided by the data center servers.

In some embodiments, the assessment system generates support scores for data storage support, computational support, security support, and so on. A hosting system may provide data storage support such as providing different levels of data storage redundancy or replication, different levels of data recovery, and so on. The different levels of support for data storage redundancy may specify how many copies of the data are stored, where the data is stored (e.g., local storage or geographically remote storage), whether the data is stored synchronously or asynchronously, and so on. The different levels of support for data recovery may be based on factors that include a recovery point objective “(RPO”) and a recovery time objective (“RTO”). A recovery point objective indicates the lag time between storing data and the asynchronous replication of that data. For example, a recovery point objective may indicate that the data will be asynchronously replicated within 30 minutes. In such a case, if a failure occurs with the primary storage, then recovery based on the replicated storage means that no more than 30 minutes of data will have been lost. Recovery time objective indicates the maximum amount of time needed to restore functionality of an application with the replicated data. For example, if an application hosted at one data center fails, a recovery time objective of two minutes may mean that the application will be up and running in a backup data center within two minutes of the failure of the data center.

A hosting system may also provide computational support such as different levels of data center resiliency and different levels of front-end resiliency. The different levels of data center resiliency may be based on factors that include geographic distribution, failover, automatic scaling, and so on. The geographic distribution factor indicates the geographic distribution of the data centers that host the application. For example, an application hosted on two data centers in the United States would not be as geographically distributed as that application being hosted on a data center in the United States and a data center in Europe. The failover factor indicates how long it will take to bypass a failed data center. For example, if a data center fails in the United States, the failover factor would be based on time needed for domain name servers (“DNS”) to be configured to route requests to a data center in Europe. The automatic scaling factor indicates whether additional data center servers will be automatically allocated to the application based on demand. The different levels of front-end resiliency may be based on factors that include geographic distribution, failover, automatic scaling, and so on. The geographic distribution factor indicates the geographic distribution of front-end centers for the application. For example, an application with front-end centers located only in the United States would not be as geographically distributed as the same number of front-end centers distributed around the world. The failover factor indicates how long it will take to bypass a failed front-end center. The automatic scaling factor indicates whether additional front-end servers will be automatically allocated to the application based on demand. The hosting system may provide different levels of other computational support such as different processor speeds, different amounts and speed of memory, different types of auxiliary processors (“GPUs”), and so on.

A hosting system may also provide security support such as different levels of authentication, different levels of malware protection, different levels of encryption, and so on. The different levels of authentication may include no authentication, single factor authentication (e.g., password), and multi-factor authentication (e.g., password and token code). The different levels of malware protection may be based on factors that include type and version of operating system used by the application, the type of antivirus software, and so on. For example, a hosting system may provide an infrastructure as a service “(IAAS”) option and platform as a service (“PAAS”) to application providers. With the IAAS option, the application provider provides the operating system for the application. In contrast, with the PAAS option, the hosting service provides the operating system for the application. The PAAS option may correspond to a higher level of support as the hosting service may be responsible for keeping the malware protection up-to-date, keeping the operating system and other software systems up-to-date, and so on. The different levels of encryption of data may be based on factors that include the encryption algorithm (e.g., Advance Encryption Standard), length of encryption key (e.g., 128, 192, or 256 bits), length of encryption block (e.g., 128 or 256 bits), and so on. For example, encryption with a 256-bit key represents a higher level of support than encryption with a 128-bit key. Other factors for the level of encryption may be based on whether communications are encrypted and data stored on the storage units are encrypted.

The assessment system may generate support scores for different types of support using various techniques. For example, the assessment system may generate scores that range between 0 and 100 or may generate scores similar to academic grades (e.g., A, B−, C+, and F.) To generate a score for a type of support, the assessment system may generate constituent scores for the levels of support of that type and then combine those constituent scores into a support score for that type of support. For example, the assessment system may maintain a mapping of the different levels of support to their corresponding constituent scores. For example, for different levels of encryption, the level of no encryption might be mapped to a constituent score of 0, a level of Advanced Encryption Standard (“AES”) encryption with a 128-bit key might be mapped to a constituent score of 90, and a level of AES encryption with a 256-bit key might be mapped to a constituent score of 100. The assessment system may combine the constituent scores into a support score using a weighted average. For example, the assessment system may weight the level of authentication as twice that of the levels of malware protection and encryption. If the constituent scores for authentication, malware protection, and encryption are 50, 40, and 80, then the assessment system may generate a support score of 37.5 (e.g., (2×50+40+10)14), rather than 33.3 without weighting. The assessment system may similarly generate a service score for an application as a weighted average of the support scores for that application. Although the setting of constituent scores and the weights may be considered subjective, the assessment system generates the overall score for an application objectively in the sense that any applications with the same levels of support will have the same overall scores.

In some embodiments, the assessment of the quality of service of an application may be provided by the provider of the hosting system or a third-party certification service. When a third-party certification service provides assessments, the certification service may collect the levels of a support for an application from the application provider or the hosting system. If the level of support is provided by the application provider, the certification service may verify the accuracy with the hosting system. In some embodiments, the assessment system may also factor into the quality of service score the levels of support determined by monitoring execution of an application, analyzing key performance indicators collected by the hosting system, analyzing the application code, and so on. The key performance indicators may include number of crashes, amount of down time, response time, resiliency to denial of service attacks, number of attempted hacks, and so on. The assessment system may generate a performance score to indicate how well the application performs. The quality of service score may also factor in whether the application is hosted by multiple independent hosting systems. If so, the quality of service is likely to be higher as the application will be more resilient to the complete failure of a single hosting system.

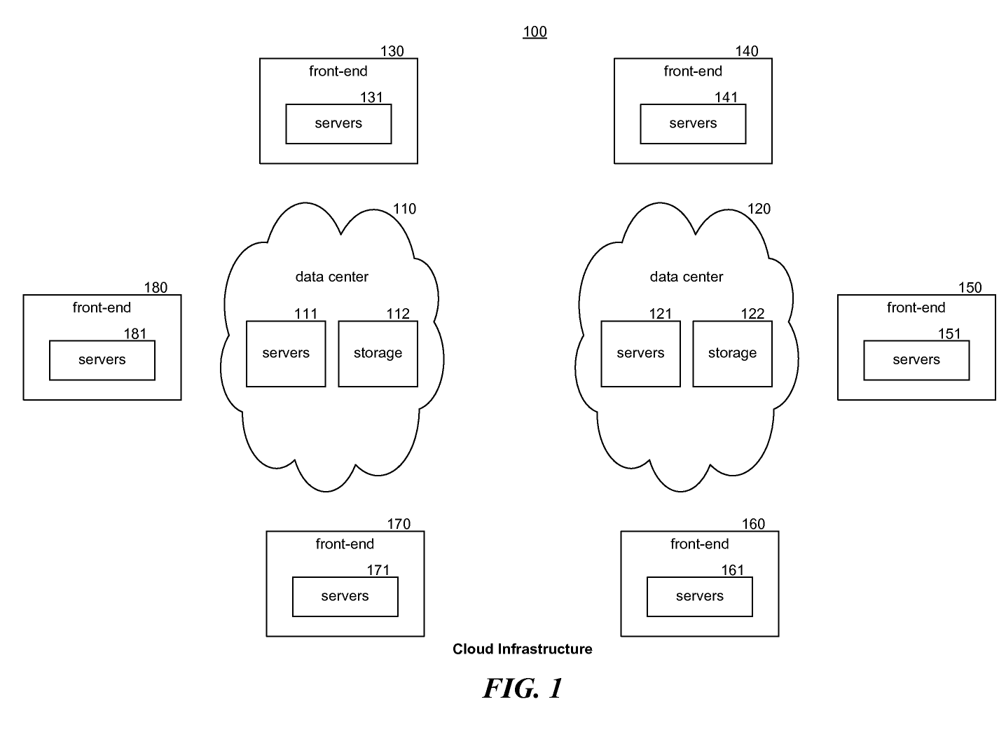

FIG. 1 is a block diagram that illustrates a cloud infrastructure. The cloud infrastructure 100 includes data centers 110 and 120 and front-end centers 130-180. The data centers 110 and 120 may be located in the United States and Europe, respectively. The front-end centers 130-180 may be located in different regions throughout the world. The data center 110 includes servers 111 and storage units 112, and the data center 120 includes servers 121 and storage unit 122. The front-end centers 130-180 include servers 131-181. The front-end centers may be connected to the data centers via the Internet, and the data centers may be connected to each other using a dedicated high-speed communication channel (e.g., fiber optics). The cloud infrastructure may also provide domain name servers (not illustrated) for routing communication from the front-end centers to the data centers.

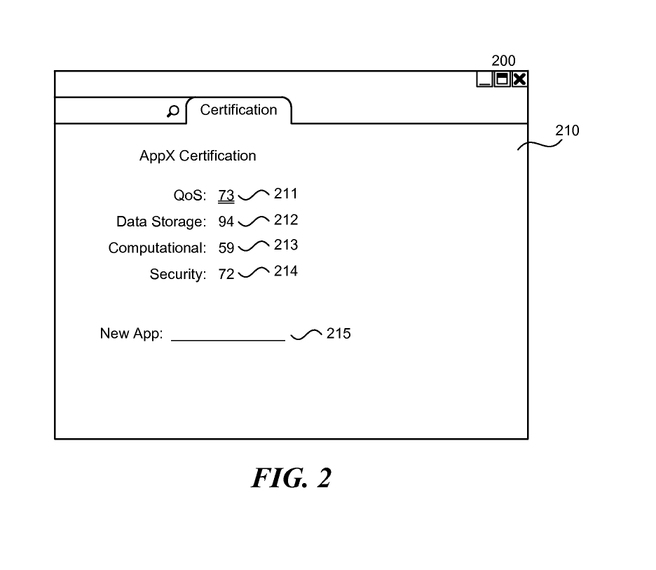

FIG. 2 illustrates a display page for providing a quality of service score for an application in some embodiments. A display page 200 includes a certification window 210 for displaying certification information for an application named “AppX.” The certification window includes a quality of service score 211, a data storage score 212, a computational score 213, and a security score 214. The certification window also includes a data entry field 215 for entering the name of a different application whose certification information is to be displayed. The assessment system may provide this display page to the general public to assist is the selecting of applications.

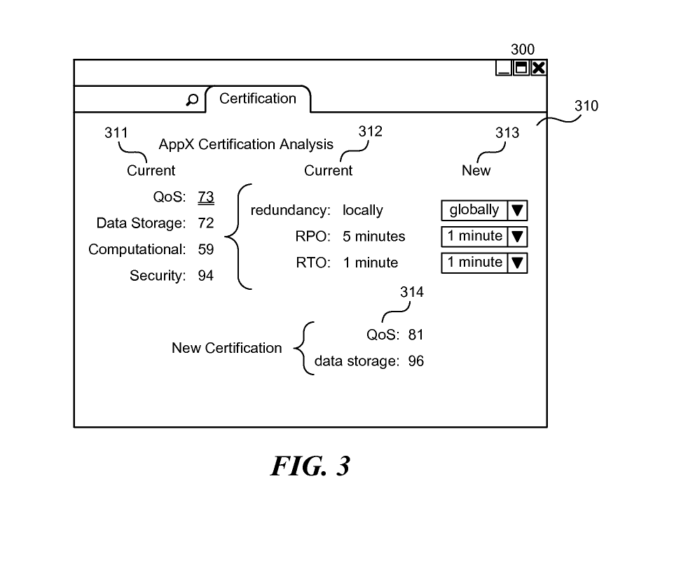

FIG. 3 illustrates a display page for assisting an application provider in analyzing the impacts of different levels of protection on the quality of a service score in some embodiments. A display page 300 includes an analysis window 310 for analyzing the impacts of different levels of support for AppX. The analysis window includes a current certification area 311, a current support area 312, data entry fields 313 for different levels of support, and a new certification area 314. The current certification area includes the current quality of service score and support scores for the application. The current support area includes current levels of constituent support for the currently selected type of support (i.e., data storage support). The current support area allows the user to view the levels of constituent support that are taken into account when generating a support score. The data entry fields may be drop-down dialog boxes for selecting new levels of constituent support. In this example, the user has selected a data storage redundancy of “globally” and a recovery point objective of “one minute.” The new certification area indicates what the quality of service score and the data storage score will be if the hosting service provides the new levels of constituent support for the application. The window may also display a constituent score for the current and new levels of constituent support. An application provider can use the analysis window to select the levels of constituent support that best meet the objectives of the application provider. The analysis window may also include financial information to indicate the impact of different levels of constituent support.

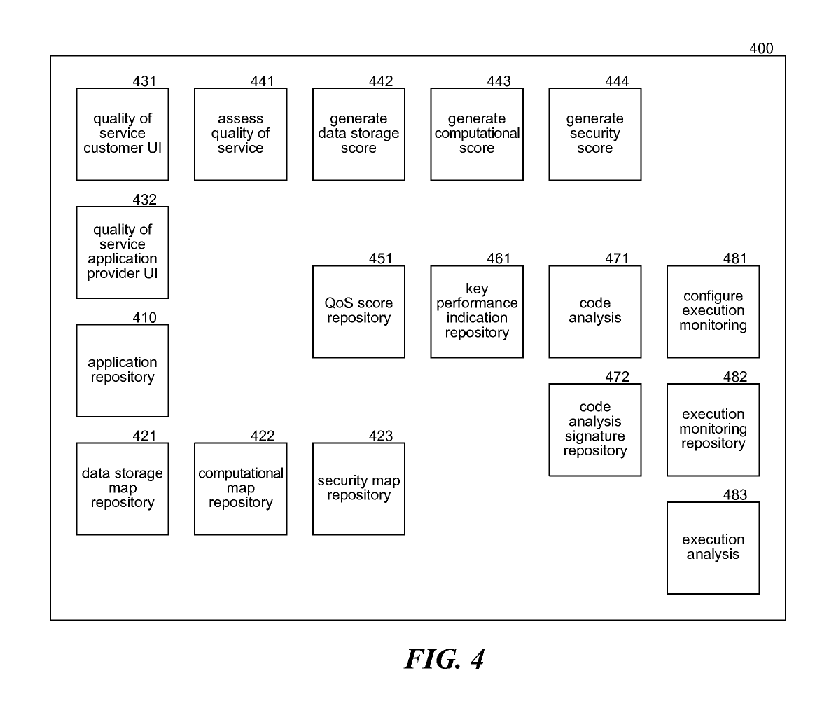

FIG. 4 is a block diagram that illustrates components of the assessment system in some embodiments. The assessment system 400 may include or access an application repository 410 that indicates, for each application, the levels of constituent support for each type of support. For example, the application repository may indicate that AppX currently has a local level of support for data storage redundancy, the recovery point objective of five minutes, and the recovery time objective of one minute. The assessment system 400 may also include a data storage map repository 421, a computational map repository 422, and a security map repository 423. Each of these repositories may map the levels of constituent support to their corresponding constituent score. In some embodiments, the different constituent supports may be mapped to code modules for calculating the corresponding constituent score. The assessment system 400 may also include a quality of service customer user interface component 431 and a quality of service application provider user interface component 432. The customer user interface component provides the certification window 210, and the application provider user interface component provides the analysis window 310. The assessment system 400 also includes an assess quality of service component 441, a generate data storage score component 442, a generate computational score component 443, and a generate security score component 444. The assess quality of service component invokes the other components to generate a quality of service score. The assessment system also includes a quality of service score repository 451 containing the current score for each application. The assessment system may also include or access a key performance indicator repository 461. The hosting system may also track key performance indicators such as response time. The assessment system in some embodiments may factor in those key performance indicators into the quality of service score. The assessment system may also include a code analysis component 471 and a code analysis signature repository 472. The code analysis component may be used to analyze the code of an application to determine the level of support provided by the application itself. The code analysis signature repository may contain signatures to be used to scan the code of the application to determine the levels of support. The assessment system may also include a configure execution monitoring component 481, an execution monitoring repository 482, and an execution analysis component 483. The configure execution monitoring component may be used to configure the operating system to collect execution information relating to the quality of service, such as logging operating system calls, recording whether data is stored redundantly, and so on. The execution information may be stored in the execution monitoring repository.

The computing devices and systems on which the assessment system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touchscreens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that includes computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the annotation system. The data transmission media is used for transmitting data via transitory, propagating signals or carrier waves (e.g., electromagnetism) via a wired or wireless connection.

The assessment system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the assessment system may be implemented in hardware using, for example, an application-specific integrated circuit (“ASIC”).

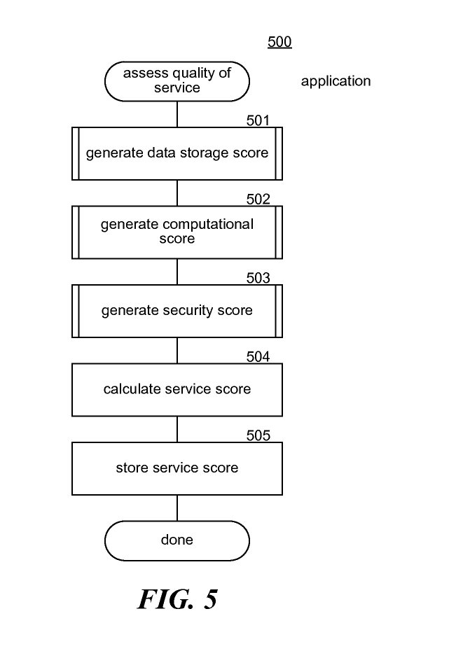

FIG. 5 is a flow diagram that illustrates the processing of an assess quality of service component of the assessment system in some embodiments. The component 500 is invoked to calculate a quality of service score for an application. In block 501, the component invokes the generate data storage score component to generate a data storage score for the application. In block 502, the component invokes the generate computational score component to generate a computational score for the application. In block 503, the component invokes the generate security score to generate a security score for the application. In block 504, the component calculates a quality of service score by combining the data storage score, the computational score, and the security score. In block 505, the component stores the quality of service score in the quality service score repository and then completes.

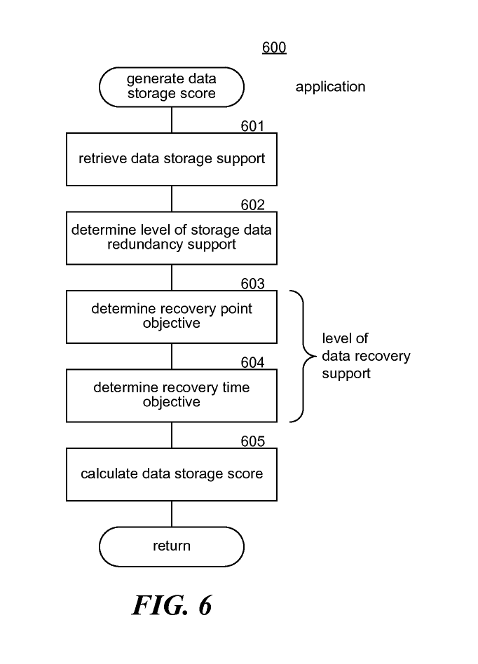

FIG. 6 is a flow diagram that illustrates the processing of a generate data storage score component of the assessment system in some embodiments. The component 600 is invoked and passed an indication of an application whose data storage score is to be generated. In block 601, the component retrieves from the application repository indications of the data storage support provided by the hosting system to the application. In block 602, the component determines the level of data storage redundancy support provided to the application. In block 603, the component determines the recovery point objective of the application. In block 604, the component determines the recovery time objective of the application. In block 605, the component calculates a data storage score by retrieving the associated constituent scores from the data storage map repository and combining the constituent scores into the support score and then returns.

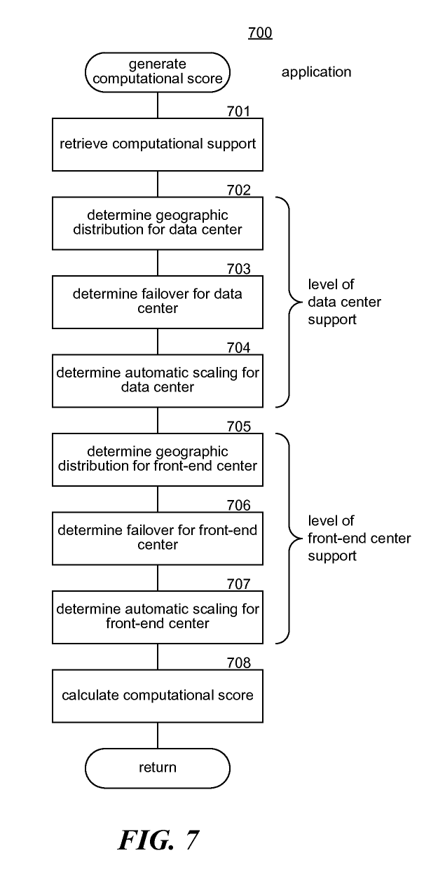

FIG. 7 is a flow diagram that illustrates the processing of a generate computational score component of the assessment system in some embodiments. The component 700 is invoked and passed an indication of an application whose computational score is to be generated. In block 701, the component retrieves from the application repository indications of the computational support provided by the hosting service to the application. In block 702, the component determines the geographic distribution support for the data centers. In block 703, the component determines the failover support for the data centers. In block 704, the component determines the automatic scaling support for the data centers. In block 705, the component determines the geographic distribution support for the front-end centers. In block 706, the component determines the failover support for the front-end centers. In block 707, the component determines the automatic scaling support for the front-end centers. In block 708, the component calculates a computational score by retrieving the associated constituent scores from the computational map repository and combining the constituent scores into the support score and then returns. The component then returns.

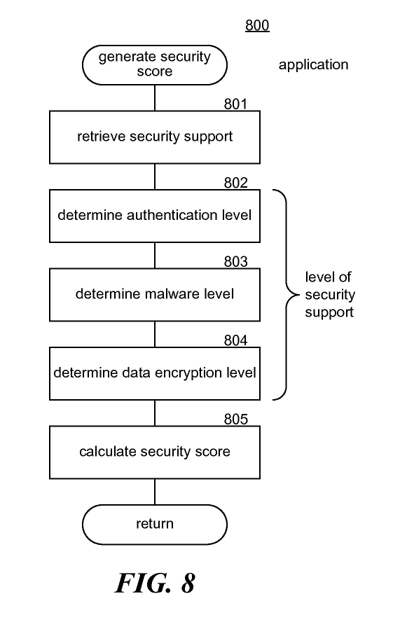

FIG. 8 is a flow diagram that illustrates the processing of a generate security score component of the assessment system in some embodiments. The component 800 is invoked and passed an indication of an application whose security score is to be generated. In block 801, the component retrieves indications of the security support provided to the application. In block 802, the component determines the level of authentication support provided to the application. In block 803, the component determines the level of malware support provided to the application. In block 804, the component determines the level of data encryption support provided to the application. In block 805, the component calculates a security score by retrieving the associated constituent scores from the security map repository and combining the constituent scores into the support score and then returns. The component then returns.

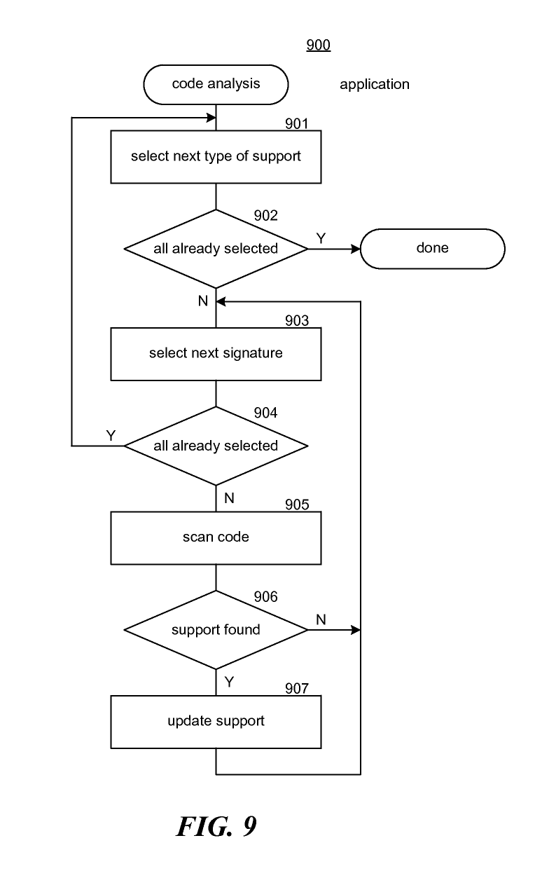

FIG. 9 is a flow diagram that illustrates the processing of a code analysis component of the assessment system in some embodiments. The component 900 is passed an indication of an application and performs a code analysis on the application to determine the level of support provided by the application. In blocks 901-907, the component loops selecting each type of support. In block 901, the component selects the next type of support. In block 902, if all the types of support have already been selected, then the component completes, else the component continues at block 903. In blocks 903-907, the component loops selecting each signature for the selected type of support and scanning the code to determine whether that signature can be found. In block 903, the component selects the next signature for the selected type of support. In decision block 904, if all the signatures have already been selected, then the component loops to block 901, else the component continues at block 905. In block 905, the component scans the code of the application to determine whether it contains the selected signature. In some embodiments, the signatures may be similar to signatures used to scan code looking for viruses or other malware. For example, a signature may be defined to correspond to a sequence of instructions for invoking an operating system's call to perform a certain level of encryption. If the code for the application contains that signature, then the application supports that level of encryption. In other embodiments, the signatures may correspond to executable code that performs sophisticated analysis on the code of the application to determine whether the code contains certain support. In decision block 906, if the level of support defined by the signature is found, then the component continues at block 907, else the component loops to block 903 to select the next signature. In block 907, the component updates the application repository to indicate that support based on that signature has been found for the application. The component then loops to block 903 to select next signature.

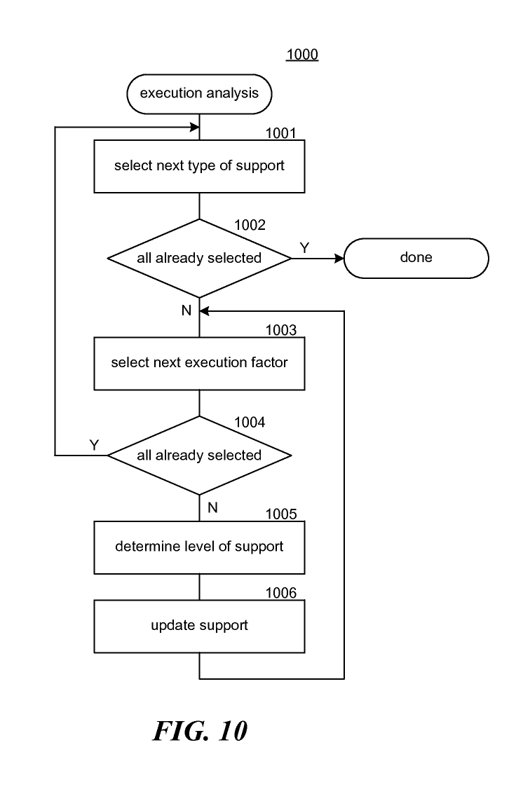

FIG. 10 is a flow diagram that illustrates the processing of an execution analysis component of the assessment system in some embodiments. The component 1000 is invoked after execution of an application has been monitored, and the results of the monitoring have been stored in the execution monitoring repository. In blocks 1001-1006, the component loops selecting each type of support and updating the level of support based on execution statistics. In block 1001, the component selects the next type of support. In decision block 1002 if all the resources have already been selected, then the component completes, else the component continues at block 1003. In blocks 1003-1006, the component loops to determine the level of support for each execution factor of the selected type of support. In block 1003, the component selects the next execution factor. In decision block 1004, if all the execution factors have already been selected, then the component loops to block 1001 to select the next type of support, else the component continues at block 1005. In block 1005, the component determines the level of support for the selected execution factor. In block 1006, the component updates the application repository to indicate the level of support for the selected execution factor and then loops to block 1003 to select the next execution factor.

### ASPECTS OF CERTAIN EMBODIMENTS

In some embodiments, the assessment system provides method performed by a computing device for assessing quality of a service provided by an application hosted by a hosting system. The method includes generating a data storage score that indicates data storage support provided by the hosting system to the application; generating a computational score that indicates computational support provided by the hosting system to the application; generating a security score that indicates security support provided by the hosting system to the application; generating a service score for the service based on the data storage score, the computational score, and security score; and providing the service score as an indication of the quality of the service provided by the application that is hosted by the hosting system. The data storage score may be based on level of support provided by the hosting system for data storage redundancy and data recovery, and the level of support for data recovery may be based on factors that include a recovery point objective and a recovery time objective. The computational score may be based on level of support provided by the hosting system for data center resiliency and front-end center resiliency. The level of support for data center resiliency may be based on factors that include geographic distribution, failover, and automatic scaling of data centers. The level of support for front-end center resiliency may be based on factors that include geographic distribution, failover, and automatic scaling. The security score may be based on level of support provided by the hosting system for authentication and malware protection and may be based on level of support provided by the hosting system for encryption. In some embodiments, the quality of service score may be a weighted average of the data storage score, the computational score, and the security score. In some embodiments, the hosting system is a cloud infrastructure where the scores are automatically generated based on level of support provided to the application by the cloud infrastructure. In some embodiments, one or more of the scores may be generated based on analyzing code of the application to assess levels of support. Also, one or more of the scores may be generated based on monitoring execution of the application to assess levels of support.

In some embodiments, a computer system for assessing quality of a service provided by an application hosted by a cloud infrastructure is provided. The cloud infrastructure may provide data storage support and computational support to the application and at least some of the data storage support and the computational support is optional support that is provided to the application by the cloud infrastructure. The computer system may comprise a component that generates a data storage score based on data storage support provided to the application by the cloud infrastructure; a component that generates a computational score based on computational support provided to the application by the cloud infrastructure; and a component that provides the generated scores as an indication of the quality of service provided by the application hosted by the cloud infrastructure. The computer system may also comprise a component that receives from a party other than a provider of the cloud infrastructure an indication of data storage support and computational support provided to the application by the cloud infrastructure and verifies the data storage support and computational support with the provider of the cloud infrastructure. The computer system may also comprise a component that generates a multiple cloud infrastructure score based on multiple cloud infrastructures providing support to the application. The computer system of claim 13 may also comprise a component that monitors execution of the application and generates a performance score indicating performance of the application.

In some embodiments, a computer-readable storage medium stores computer-executable instructions for controlling a computing device to provide an assessment of quality of service provided by an application. The computer-executable instructions may comprise instructions for identifying support provided to the application by a hosting system that hosts the application, wherein the hosting system provides varying levels of support to applications; generating one or more scores based on the identified level of support provided to the application by the hosting system; and providing the generated one or more scores as an indication of the quality of service provided by the application. In some embodiments, the identifying of the support may include receiving from a party other than a provider of the hosting system an indication of the level of support and verifying the received level of support with the provider of the hosting system. In some embodiments, the support provided to the application may include one or more of data storage support, computational support, and security support. The computer-readable storage medium may include instructions for assessing quality of a client-side component of the application and factoring the assessed quality of the client-side component when generating one or more scores.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by a computing device for assessing quality of a service provided by an application hosted by a hosting system, the method comprising:
generating a data storage score that indicates data storage support provided by the hosting system to the application;
generating a computational score that indicates computational support provided by the hosting system to the application;
generating a security score that indicates security support provided by the hosting system to the application;
generating a service score for the service based on the data storage score, the computational score, and the security score; and
providing the service score as an indication of the quality of the service provided by the application that is hosted by the hosting system.

2. The method of claim 1 wherein the data storage score is based on level of support provided by the hosting system for data storage redundancy and data recovery.

3. The method of claim 2 wherein the level of support for data recovery is based on factors that include a recovery point objective and a recovery time objective.

4. The method of claim 1 wherein the computational score is based on a level of support provided by the hosting system for data center resiliency and front-end center resiliency.

5. The method of claim 4 wherein the level of support for data center resiliency is based on factors that include geographic distribution, failover, and automatic scaling of data centers.

6. The method of claim 4 wherein the level of support for front-end center resiliency is based on factors that include geographic distribution, failover, and automatic scaling.

7. The method of claim 1 wherein the security score is based on level of support provided by the hosting system for authentication and malware protection.

8. The method of claim 1 wherein the security score is based on level of support provided by the hosting system for encryption.

9. The method of claim 1 wherein the quality of service score is a weighted average of the data storage score, the computational score, and the security score.

10. The method of claim 1 wherein the hosting system is a cloud infrastructure and wherein scores are automatically generated based on level of support provided to the application by the cloud infrastructure.

11. The method of claim 1 wherein one or more of scores are generated based on analyzing code of the application to assess levels of support.

12. The method of claim 1 wherein one or more of scores are generated based on monitoring execution of the application to assess levels of support.

13. A computer system for assessing quality of a service provided by an application hosted by a cloud infrastructure, the cloud infrastructure providing data storage support and computational support to the application, at least some of the data storage support and the computational support is optional support that is provided to the application by the cloud infrastructure, the computer system comprising:
a component that generates a data storage score based on data storage support provided to the application by the cloud infrastructure;
a component that generates a computational score based on computational support provided to the application by the cloud infrastructure; and
a component that provides the generated scores as an indication of the quality of service provided by the application hosted by the cloud infrastructure.

14. The computer system of claim 13 further comprising:
a component that receives from a party other than a provider of the cloud infrastructure an indication of the data storage support and the computational support provided to the application by the cloud infrastructure and verifies the data storage support and computational support with the provider of the cloud infrastructure.

15. The computer system of claim 13 further comprising:
a component that generates a multiple cloud infrastructure score based on multiple cloud infrastructures providing support to the application.

16. The computer system of claim 13 further comprising:
a component that monitors execution of the application and generates a performance score indicating performance of the application.

17. A computer-readable storage medium storing computer-executable instructions for controlling a computing device to provide an assessment of quality of service provided by an application, the computer-executable instructions comprising instructions for:
identifying support provided to the application by a hosting system that hosts the application, wherein the hosting system provides varying levels of support to applications;
generating one or more scores based on the identified level of support provided to the application by the hosting system; and
providing the generated one or more scores as an indication of the quality of service provided by the application.

18. The computer-readable storage medium of claim 17 wherein identifying the support includes receiving from a party other than a provider of the hosting system an indication of the level of support and verifying the received level of support with the provider of the hosting system.

19. The computer-readable storage medium of claim 17 wherein the support provided to the application includes one or more of data storage support, computational support, and security support.

20. The computer-readable storage medium of claim 17 including assessing a level of quality of a client-side component of the application and factoring the assessed level of quality of the client-side component when generating one or more scores.
